(19) United States
(12) Patent Application Publication
(10) Pub. No.: US 2021/0174231 A1
(43) Pub. Date: Jun. 10, 2021

(54) MODEL GENERATION DEVICE, MODEL GENERATION METHOD, AND NON-TRANSITORY RECODING MEDIUM

(71) Applicant: NEC Corporation, Minato-ku, Tokyo (JP)

(72) Inventors: Azusa SAWADA, Tokyo (JP); Takashi SHIBATA, Tokyo (JP); Katsuhiko TAKAHASHI, Tokyo (JP)

(73) Assignee: NEC Corporation, Minato-ku, Tokyo (JP)

(21) Appl. No.: 17/263,738

(22) PCT Filed: Aug. 2, 2018
(86) PCT No.: PCT/JP2018/028965

§ 371 Date: Jan. 27, 2021

(51) Int. Cl. G06N 5/04; G06N 20/00

(52) U.S. Cl. CPC G06N 5/04; G06N 20/00

(57) ABSTRACT

Disclosed is a model generation device capable of mitigating the risk of overlooking a phenomenon of interest in machine learning. The model generation device determines whether or not a label of a first data is similar to a label of a second data. The model generation device assigns the label of the second data to the first data when determining that the label of the first data is similar to the label of the second data based on a degree of similarity between observation information representing a state where the first data is observed and observation information representing a state where the second data is observed. The model generation device calculates model representing a relevance between data information containing the first data and the second data and label information containing the assigned label and the label of the second data.

### TECHNICAL FIELD

The present invention is related to a model generation device and the like that generates a model for predicting, for example, a state of an observation target.

### BACKGROUND ART

Machine learning is useful, for example, as a technique for identifying whether a product produced in a factory is defective. For example, machine learning generates a model for estimating (predicting) a label for a given data based on data (hereinafter, referred to as “training data”) which associates data with a label representing whether an event of interest (hereinafter, referred to as “target event”) occurs regarding the data. The model is information indicating the relevance between the data and the label.

In training data, data may be associated (or, allocated, assigned) with a low quality label. Machine learning optimizes a model to give, for the data, a label assigned to the data. For this reason, machine learning may generate a model with low discrimination performance when using a low quality label or the like.

If a target event is product defect, product deterioration, organ lesion, or the like, it is desirable to detect the defect, lesion, or the like, at the smallest possible stage and at an early stage. In the case of detecting the target event using machine learning, assigning a high quality label to the data leads to the generation of a model with high discrimination performance. However, obtaining a high quality label requires detail analysis of data and results in very high costs. Thus, it is substantially difficult to assign a high quality label to large amounts of data, or to correct a low quality label to assign a correct label to the data.

NPL 1 discloses machine learning for generating a model for training data including incorrect labels. The machine learning selects a label deviating from the tendency of the entire training data as an incorrect label, corrects the selected incorrect label, and generates a model based on the corrected label. Alternatively, the machine learning generates a model without emphasizing data related to the incorrect label.

PTL 1 discloses a machine learning device that learns failure prediction of a main shaft or a motor driving the main shaft.

### CITATION LIST

### Patent Literature

PTL 1: Japanese Patent Publication No. 6140331

### Non-Patent Literature

NPL 1: Daiki Tanaka, Daiki Ikami, Toshihiko Yamasaki and Kiyoharu Aizawa, “Joint Optimization Framework for Learning with Noisy Labels” Computer Vision and Pattern Recognition (CVPR), Salt Lake City, USA, Jun. 19, 2018-Jun. 21, 2018.

### SUMMARY OF INVENTION

### Technical Problem

However, the machine learning device disclosed in PTL 1 determines weights of data depending on a length of time and learns failure prediction based on the weighted data, but cannot detect an incorrect label.

Further, the machine learning disclosed in NPL 1 does not always correctly detect an incorrect label. This is because the machine learning cannot detect an incorrect label having consistent tendency in training data, for example. An incorrect label having consistent tendency is likely to occur, for example, near a discrimination boundary in a model. As a result, when the machine learning is used in a system for predicting a defect or the like of the product while the product is produced, there is a risk of overlooking the defect because the machine learning makes an error in prediction.

Accordingly, one object of the present invention is to provide a model generation device or the like capable of reducing a risk of overlooking a target event.

### Solution to Problem

As an aspect of the present invention, a model generation device includes:

label control means for determining whether or not a label of a first data is similar to a label of a second data and assigning the label of the second data as a label of the first data when determining that the label of the first data is similar to the label of the second data based on a degree of similarity between observation information representing a state where the first data is observed and observation information representing a state where the second data is observed; and

model generation means for calculating model representing a relevance between data information containing the first data and the second data and label information containing the assigned label and the label of the second data.

As another aspect of the present invention, a model generation method by an information processing device includes:

determining whether or not a label of a first data is similar to a label of a second data and assigning the label of the second data as a label of the first data when determining that the label of the first data is similar to the label of the second data based on a degree of similarity between observation information representing a state where the first data is observed and observation information representing a state where the second data is observed; and

calculating model representing a relevance between data information containing the first data and the second data and label information containing the assigned label and the label of the second data.

As another aspect of the present invention, a model generation program causes a computer to achieve:

a label control function for determining whether or not a label of a first data is similar to a label of a second data and assigning the label of the second data as a label of the first data when determining that the label of the first data is similar to the label of the second data based on a degree of similarity between observation information representing a state where the first data is observed and observation information representing a state where the second data is observed; and

a model generation function for calculating model representing a relevance between data information containing the first data and the second data and label information containing the assigned label and the label of the second data.

Furthermore, the object is also achieved by a computer-readable recording medium that records the program.

### Advantageous Effects of Invention

A model generation device or the like according to the present invention can achieve reduction of a risk of overlooking a target event.

### BRIEF DESCRIPTION OF DRAWINGS

FIG. 1 is a block diagram showing a configuration of a model generation device according to a first example embodiment of the present invention.

FIG. 2 is a flowchart showing a flow of processing in the model generation device according to the first example embodiment.

FIG. 3 is a diagram conceptually showing an example of a data sequence.

FIG. 4 is a block diagram showing a configuration of a model generation device according to a second example embodiment of the present invention.

FIG. 5 is a flowchart showing a flow of processing in the model generation device according to the second example embodiment.

FIG. 6 is a block diagram schematically illustrating a hardware configuration of a calculation processing device capable of achieving a model generation device according to each of example embodiments of the present invention.

### EXAMPLE EMBODIMENT

Next, an example embodiment of the present invention will be described in detail with reference to the drawings.

### First Example Embodiment

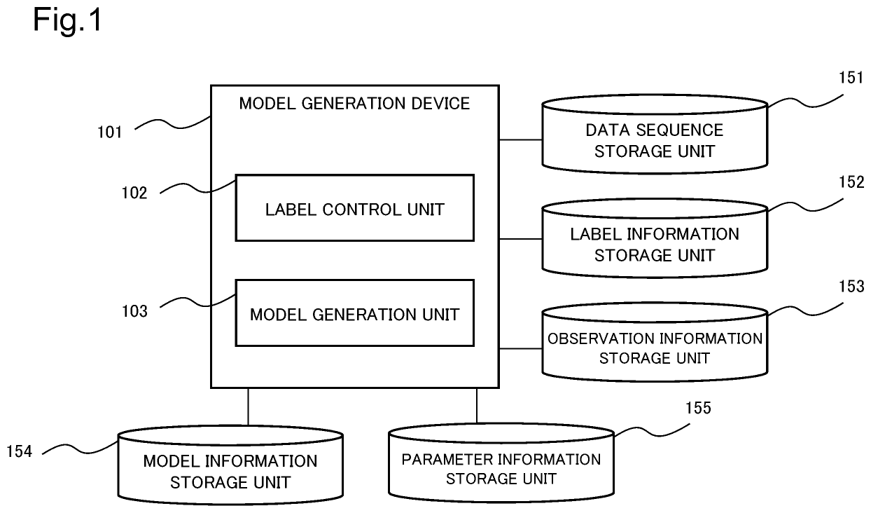

Referring to FIG. 1, a configuration of a model generation device 101 according to a first example embodiment of the present invention will be described in detail. FIG. 1 is a block diagram showing a configuration of the model generation device 101 according to the first example embodiment of the present invention.

The model generation device 101 according to the first example embodiment includes a label control unit 102 and a model generation unit 103.

The model generation device 101 is communicatively connected to a data sequence storage unit 151, a label information storage unit 152, an observation information storage unit 153, a model information storage unit 154, and a parameter information storage unit 155. The model information storage unit 154, the data sequence storage unit 151, the label information storage unit 152, the observation information storage unit 153, and the parameter information storage unit 155 may be a single storage device or a plurality of storage devices.

The data sequence storage unit 151 can store data observed (measured) in an observation environment where an observation target is located. Information representing the observation environment is referred to as “observation information”.

The observation information represents, for example, a certain time interval for observing an observation target. In this case, the data is, for example, image data representing an image of an observation target. The data may be text data or binary data. The observation information represents, for example, a predetermined illumination angle for observing an observation target in a situation that is a condition under light irradiation at the predetermined illumination angle to the observation target. In this case, the data is, for example, image data representing an image of an observation target under a situation of light irradiation at the predetermined illumination angle. For convenience of explanation, a series of data obtained by observing an observation target in an observation environment is referred to as “data sequence”. The data sequence is, for example, a series of image data representing an image of an observation target every 0.1 seconds in ten seconds, a series of image data representing an image of an observation target at a plurality of resolutions, or a series of image data representing an image of an observation target at a plurality of angles. The data sequence storage unit 151 may store data for each data sequence.

The data sequence is, for example, a temporal data sequence representing data observed with respect to an observation target over time, or a spatial data sequence representing data observed with respect to an observation target while changing the angle of light irradiation.

The temporal data sequence is, for example, a collection of data acquired by measuring an observation target at a certain time interval. The time interval may be a constant time interval or a non-constant time interval. The temporal data sequence is, for example, a collection of image data acquired by imaging an organ of a patient at a certain time interval. The temporal data sequence may be a collection of data acquired at regular time intervals, such as a video image. The time interval need not be a second, but may be a unit such as an hour, a date, an age, or the like. The certain time interval is not limited to the examples described above.

The spatial data sequence is a collection of data acquired by observing an observation target in a certain observation environment. The certain observation environment represents observation while varying, for example, noise intensity, resolution, and the like at a given interval. The certain observation environment represents, for example, measuring an observation target while changing the angle at which light is emitted to the observation target. The certain observation environment represents, for example, measuring an observation target while changing the altitude at which the observation target is imaged. The certain observation environment is not limited to the examples described above. The spatial data sequence is a collection of image data acquired by imaging an observation target (for example, inspection target) at a predetermined illumination angle.

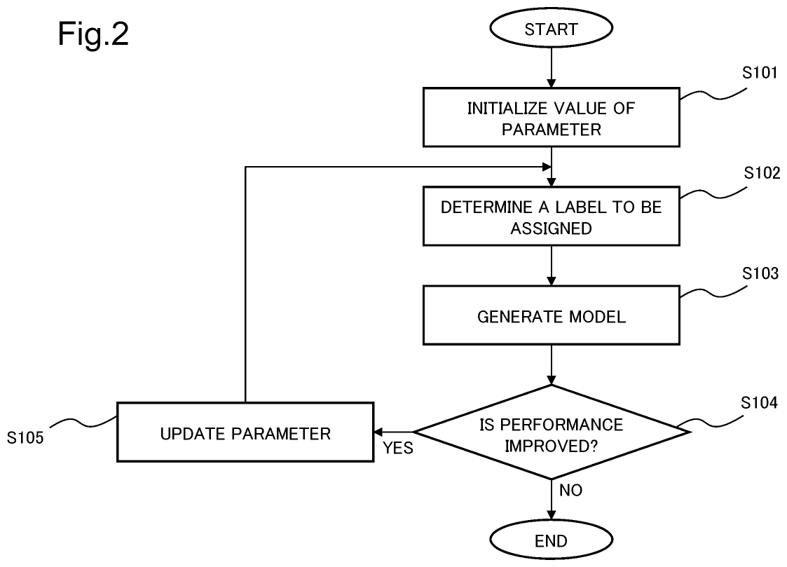

The data in the data sequence need not necessarily be data representing only an observation target, and may be data representing information including an observation target. For example, when the data sequence is a series of image data acquired by imaging an observation target, the data may be image data including an area where the observation target is imaged and an area where the observation target is not imaged. In such a case, the image data may be classified into the area of the observation target and the area not including the observation target by using a video image processing technique, and the processing described later with reference to FIG. 2 may be performed in each area, and then the results may be stored in association with each other. Alternatively, the data sequence may be data representing areas associated with each other in the image data in the data sequence. In other words, in this case, the data sequence may be image data in which the associated areas are divided into one data sequence by using a video image processing technique.

The label information storage unit 152 can store label information representing a label assigned to data. The label may be given to each data in a data sequence or to a part of the data in a data sequence. The label information is information representing a label such as a positive label and a negative label. The positive label is, for example, a label indicating that a target event is occurring in an observation target. The negative label is, for example, a label indicating that no target event is occurring in an observation target. The label information may be a numerical value indicating the possibility of being a positive label or a label (hereinafter, referred to as “soft label”) such as a numerical value indicating the possibility of being a negative label.

When the observation target is a product, it is assumed that the target event is a defect in the product. In this case, the positive label is assigned to data representing a product having a defect, for example. When the observation target is an organ, it is assumed that the target event is a lesion of the organ. In this case, the positive label is assigned, for example, to data representing the organ having the lesion. On the other hand, the negative label is a label different from the positive label. When the observation target is an organ, the negative label is assigned to data representing, for example, an organ in which no lesion has been detected or data representing a normal organ. The positive label may be further subdivided into a plurality of positive labels. The label, the positive label, and the negative label are not limited to the examples described above.

Hereinafter, the data to which a positive label is assigned (allocated) is denoted as “positive data”. The data to which a negative label is assigned (allocated) is denoted as “negative data”.

One data sequence may include positive data and negative data, may include only positive data, or may include only negative data. One data sequence may include unlabeled data representing data to which no label is assigned. The label assigned to data in one data sequence is not necessarily a fixed label.

Hereinafter, for convenience of explanation, it is assumed that either a positive label or a negative label is assigned to each data in a data sequence.

The observation information storage unit 153 can store observation information representing an observation environment (observation requirements and observation conditions) in which data related to an observation target has been observed. The observation information may be, for example, numerical data such as a time point and angle. As described above, the observation information represents a certain time interval when, for example, an observation target is observed at a certain time interval. The observation information represents, for example, a predetermined illumination angle when an observation target is observed under a situation of light irradiation at the predetermined illumination angle to an observation target. The observation information may be, for example, information representing an order of a time point in which an observation target is observed at a certain time interval. The observation information may be, for example, information representing a time interval in which an observation target is observed at a certain time interval. The observation environment may be information representing an altitude when an observation target is imaged from a flying object such as a drone or an airplane, or information representing a moving distance when an observation target is observed from a moving object such as an automobile or a two-wheeled vehicle. The observation information may represent, for example, a resolution when an observation target is imaged, a position when an observation target is imaged, and the like. The observation information may also represent the difference (gap) between two observation environments in which an observation target has been observed. In this case, the observation information represents, for example, a difference between two time points (for example, time interval). The observation information may be, for example, information that cannot be described using numerical values such as weather, day of the week, and character strings.

The more similar the pieces of observation information representing each observation environment in the plurality of observation environments are, the more similar the plurality of observation environments are. The larger the difference between pieces of observation information representing each observation environment in the plurality of observation environments is, the more the plurality of observation environments are not similar to each other. Therefore, the more similar the pieces of observation information representing each observation environment in the plurality of observation environments, the more likely it is that the pieces of data observed in each observation environment are assigned with a certain label. In addition, the larger the difference between pieces of observation information representing each observation environment in the plurality of observation environments, the higher the possibility that the pieces of data observed in each observation environment are assigned with mutually different labels.

When the data sequence is a temporal data sequence, the observation information is, for example, information indicating a time point of measuring each piece of data, an order of measuring each piece of data, or a time interval. When the data sequence is a spatial data sequence, the observation information is, for example, information representing noise intensity or illumination angle. The observation information is not limited to the example described above.

The observation information does not necessarily have to be explicitly indicated, but can be achieved by the order of the data in the data sequence. This example will be described.

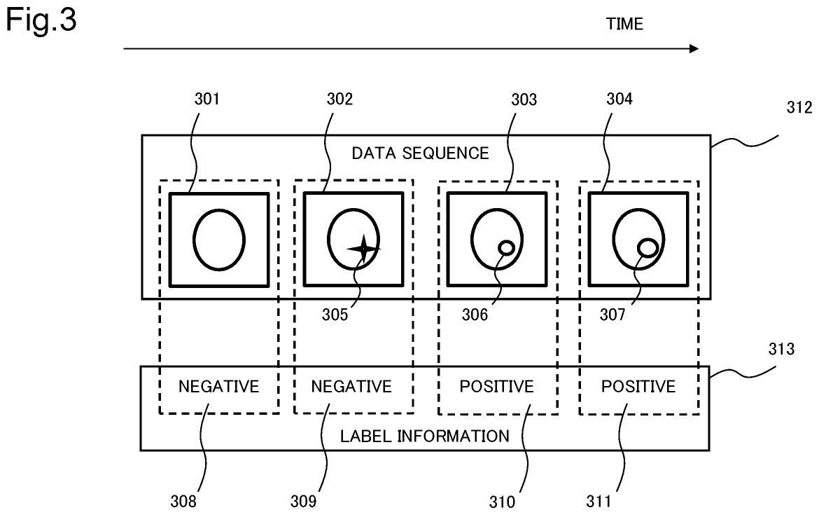

The data sequence storage unit 151 may store data sequences in which data are arranged in an order of observation information (ascending or descending). Hereinafter, the observation information is assumed to be numerical data for convenience of explanation. Further, it is assumed that the data sequence storage unit 151 stores data sequences in which data are arranged in the order of observation information (ascending or descending). In the case where the observation information is a time point, pieces of data observed for an observation target are arranged in the order of the time series in the data sequence. Further, when the observation information is numerical data such as an illumination angle, pieces of observed data on the observation target are arranged in the order of the numerical data represented by the observation information. That is, in such a case, it can be said that the observation information is achieved by the order of the pieces of data in the data sequence. As described above, by arranging the data in the order of the observation information (ascending or descending) in the data sequence, it is possible to achieve an advantageous effect that a process of assigning a label on the data can be simplified. The data sequence will be described later with reference to FIG. 3.

The model information storage unit 154 can store a model indicating the relevance (relationship) between the data stored in training data and their labels. The model may be, for example, a neural network, a support vector machine, or a decision tree. The model is not limited to the example described above.

The parameter information storage unit 155 can store parameters of the model. The parameters are weights in the neural network, a bias, or the like. The parameter are parameters or the like representing a discrimination boundary calculated by a support vector machine. The model is not limited to the examples described above. The parameters are not limited to the examples described above.

Referring to FIG. 3, a data sequence stored in the data sequence storage unit 151 will be described. FIG. 3 is a diagram conceptually showing an example of a data sequence.

The data sequence storage unit 151 illustrated in FIG. 3 stores, for example, a data sequence 312 including pieces of data 301 to 304. In this example, each of the pieces of data 301 to 304 is image data in the data sequence 312.

Each of the pieces of data 301 to 304 is assigned with a label represented by label information. The rectangle drawn using dotted lines in FIG. 3 conceptually represents that a label is assigned (allocated) to the data. The data 301 is assigned with a negative label 308. The data 302 is assigned with a negative label 309. The data 303 is assigned with a positive label 310. The data 304 is assigned with a positive label 311. The negative label 308, the negative label 309, the positive label 310, and the positive label 311 are stored as label information 313 in the label information storage unit 152.

In the data sequence illustrated in FIG. 3, the observation information represents a time point. In the data sequence 312, the pieces of data 301 to 304 are arranged in the ascending order of the time along the arrow. When the data sequence is a temporal data sequence, the direction of the arrow indicates elapse (transition) of the time (that is, the increasing direction in of the time). Thus, in this example, the pieces of data 301 to 304 represent the observed data with respect to the observation target as time passes.

The data 302 includes information representing an event 305 that has occurred with respect to the observation target. The event 305 represents, for example, an event that has occurred with respect to the observation target but is of a small scale. The data 303 includes information representing an event 306 that has occurred with respect to the observation target. The data 304 includes information representing an event 307 that has occurred with respect to the observation target. The event represents a target event such as a defect, a lesion, or the like occurring in the observation target.

In the example shown in FIG. 3, the data 303 includes information indicating an event 306 and is further assigned with the positive label 310. As similar to this, the data 304 includes information indicating the event 307 and is further assigned with the positive label 311. The data 301 includes no information indicating an event and is further assigned with the negative label 308.

Thus, the data 301, the data 303, and the data 304 are assigned with correct labels. On the other hand, although the data 302 includes information indicating the event 305, the data 302 is further assigned with the negative label 309. Therefore, the data 302 is assigned with an incorrect label. This indicates, for example, that a person or a device that has assigned the label has overlooked the event 305, even though the data 302 includes the information indicating the event 305, and therefore, the data 302 has been assigned with the negative label 309.

Next, referring to FIG. 2, the processing in the model generation device 101 according to the first example embodiment of the present invention will be described in detail. FIG. 2 is a flowchart showing a flow of processing in the model generation device 101 according to the first example embodiment.

The label control unit 102 initializes parameters such as a range (or threshold) and values of parameters of a model (step S101). The range (or threshold) represents a criterion for determining a label to be assigned to the data based on observation information related to the data.

The label control unit 102 reads a data sequence stored in the data sequence storage unit 151. The label control unit 102 reads label information related to each piece of data in the read data sequence, from the label information storage unit 152, and further reads observation information related to the data from the observation information storage unit 153.

The label control unit 102 determines a label to be assigned to the data depending on whether the observation information read regarding the data is within a range (step S102). The label control unit 102 assigns a positive label to the data when the observation information read regarding the data is within the range. The label control unit 102 assigns a negative label to the data when the observation information read regarding the data is out of the range.

The label control unit 102 assigns a positive label to data having observation information within the range of distance between the observation information and the observation information related to the positive data. The label control unit 102 assigns a negative label to data having observation information outside of the range of distance between the observation information and the observation information related to the positive data.

In other words, the label control unit 102 assigns a label related to the second data (for example, a positive label) to the first data having the observation information being similar to (or the same as) the observation information related to the second data (for example, a positive data). The label control unit 102 assigns a label different from a label related to the second data (for example, a negative label) to the first data having the observation information being not similar to (or not the same as) the observation information related to the second data (for example, a positive data).

In other words, in step S102, the label control unit 102 assigns a label related to the second data (for example, a positive label) to the first data having the observation information within a range measured from the observation information related to the second data (for example, a positive data). In step S102, the label control unit 102 assigns a label different from a label related to the second data (for example, a negative label) to the first data having the observation information out of the range measured from the observation information related to the second data (for example, a positive data).

Parameters such as ranges may be plural. For example, the label control unit 102 assigns a positive label to first data having observation information within a first range measured from the observation information related to the positive data. The label control unit 102 assigns a label “positive close to negative” as a soft label to the first data having observation information in a second range larger than the first range. The label control unit 102 assigns a negative label to the first data having observation information in the other range. The soft label is not limited to three types of labels, and may be four or more labels. The soft labels, ranges, and thresholds are not limited to the examples described above.

Hereinafter, the observation information is assumed to numerical data for convenience of explanation. The range is a range related to a distance measured from observation information related to positive data. When numerical data concerning the data is within the range, a positive label is assigned to the data. When numerical data concerning the data is out of the range, a negative label is assigned to the data. However, the distance may be an index such as similarity.

The label control unit 102 may assign a positive label to each piece of data in a data sequence when the data sequence includes positive data. In this case, the label control unit 102 assumes that pieces of observation information related to the data included in the data sequence are similar to each other.

The label control unit 102 does not necessarily assign a discrete label such as a positive label or a negative label to the data, but may assign a continuous soft label (for example, a number representing the likelihood of a positive label) determined in accordance with the similarity to the observation information related to the positive data, for example. That is, in this case, the label control unit 102 assigns, for example, numerical data indicating the likelihood of a positive label as a soft label depending on the similarity. The model generation unit 103 calculates a model showing the relevance between the data in the data sequence and the soft label based on the soft label assigned by the label control unit 102.

The processing of the label control unit 102 in a case where the soft label has been assigned will be described. For example, based on similarity of observation information with data having a higher likelihood of a positive label than the data included in the data sequence, the label control unit 102 assigns a soft label which approximates the likelihood of a positive label of data to a referenced high positive label. However, the original soft label may be converted into a positive label and a negative label by processing based on threshold, resulting in a method in a case where a positive label or a negative label is given.

The label control unit 102 calculates a range (or threshold) of observation information used for determining a label assignment. The label control unit 102 performs a grid search for parameters such as a threshold and a scale parameter related to the similarity of the observation information, and determines a range (for example, the range in the case where the discrimination performance becomes high) on the basis of the search result. The grid search is a method for determining a range based on a value when, for example, a predetermined value is set for the parameter, and when the model generation unit 103 generates a model based on the set value, the discrimination performance of the generated model is improved.

After step S102, the model generation unit 103 reads the label assigned by the label control unit 102. The model generation unit 103 generates a model showing the relevance between the read label and data based on training data associating the data with their labels (step S103). The model generation unit 103 calculates parameters of the model by using the training data in accordance with a predetermined model generation procedure, for example. The predetermined model generation procedure is, for example, a generation procedure of a neural network or a generation procedure of a support vector machine. The model generation unit 103 stores the generated model in the model information storage unit 154. The model generation unit 103 may store the determined values of the parameters in the parameter information storage unit 155.

When the model is a neural network, for example, the model generation unit 103 determines values of parameters when an objective function is the minimum in accordance with the gradient method. The objective function is, for example, a cross-entropy error function of the output and the label. The model generation unit 103 stores the calculated weights and biases in the neural network, for example, in the parameter information storage unit 155. The model generation unit 103 stores the calculated neural network, for example, in the model information storage unit 154. If the model is a neural network, parameters such as weights and biases may be initialized in step S101, and fine tuning may be performed in step S103 after updating the label control parameter, using the values in the preceding step as initial values.

The model generation unit 103 predicts a label related to data by applying a model to the data (or a feature representing the data). The model generation unit 103 may calculate a confidence degree for each label (for example, positive label and negative label) with respect to the data.

The model generation unit 103 calculates discrimination performance of the generated model by using, for example, training data or validation data for discrimination performance of the model. Hereinafter, an index representing discrimination performance is referred to as “performance information”. Therefore, the model generation unit 103 generates performance information related to the generated model. The data used to validate discrimination performance of the model may be data assigned with a label. In other words, the data used to validate discrimination performance of the model may be a data sequence used to calculate the model or a data sequence different from the data sequence used in model generation. The model generation unit 103 calculates, for example, an area under curve (AUC) as discrimination performance by using a label related to data and a label predicted with respect to the data based on the model generated by the model generation unit 103. The curve is information indicating the discrimination performance of a model such as a receiver operating characteristic curve (ROC curve). The area above the curve may be used as the discrimination performance. The discrimination performance is not limited to the AUC, and a performance index used in machine learning is usable. The discrimination performance may be an index based on an objective function including a size of the range as described above, for example.

The AUC is, for example, a value between 0.5 and 1. The higher the discrimination performance, the closer the AUC is to 1. The lower the discrimination performance, the closer the AUC is to 0.5. Since the AUC is a generally known index, a detailed description will be omitted in the present example embodiment.

The model generation unit 103 inputs the calculated performance information (for example, the AUC) to the label control unit 102.

The label control unit 102 reads the discrimination performance calculated by the model generation unit 103. The label control unit 102 determines whether the discrimination performance has been improved for the data in the data sequence based on the read discrimination performance (step S104). The label control unit 102 compares the calculated discrimination performance with respect to at least two pieces of observation information to determine whether the discrimination performance has been improved. The model generation device 101 repeatedly performs the processing in steps S102 to S105 to calculate the discrimination performance with respect to the two pieces of observation information. The model generation device 101 searches for values of parameters when the discrimination performance is improved by the processing shown in steps S102 to S105.

When the discrimination performance has been improved (YES in step S104), the label control unit 102 updates parameters such as ranges (step S105). In step S105, the label control unit 102 expands the range for determining to be a positive label, for example. That is, the label control unit 102 expands the range for determining to be the label related to the second data in step S105. Therefore, in this case, the number of the first data to which the label related to the second data is given increases. Thereafter, the processing shown in step S102 runs.

If the discrimination performance has not been improved (NO in step S104), the label control unit 102 outputs a model related to the discrimination performance or a model related to the previous discrimination performance. The label control unit 102 may further calculate values of parameters of the model. This processing will be described in detail.

The discrimination performance calculated based on the parameters updated in step S105 is referred to as “second discrimination performance”. The discrimination performance calculated based on the parameters before updating in step S105 is referred to as “first discrimination performance”.

The label control unit 102 compares the first discrimination performance with the second discrimination performance. When the second discrimination performance is higher than the first discrimination performance, the label control unit 102 expands the range for determining a positive label (that is, determining a label related to the second data), and further calculates the discrimination performance in the case of the changed range on the basis of the expanded range. In the same manner, the model generation device 101 repeats the processing shown in steps S102 to S105 until the discrimination performance is deteriorated.

When the second discrimination performance is equal to or lower than the first discrimination performance, the label control unit 102 determines, for example, a range in the case where the discrimination performance is the first discrimination performance as a range for determining a positive label (that is, determining a label related to the second data.). When the second discrimination performance is equal to or lower than the second discrimination performance, the label control unit 102 may determine, for example, a range in the case where the discrimination performance is the first discrimination performance as a range for determining a positive label (that is, determining a label related to the second data.).

In other words, the label control unit 102 searches for a range for determining a positive label based on the discrimination performance while expanding the range for determining a positive label. That is, the model generation device 101 updates the range when the discrimination performance increases, and determines the range when the discrimination performance decreases.

The processing of searching for the range is not limited to the above-described example. For example, the processing may include repeating a process of updating the range and a process for the discrimination performance in a case of the updated range, and calculating the range in the case of the highest discrimination performance among the pieces of calculated discrimination performance.

The objective function may further include a penalty term for the propagation range of the positive label. The penalty term is, for example, a term in which the larger the range of the positive label, the smaller the value, and the smaller the range, the larger the value. Therefore, when the objective function includes the penalty term, the model generation unit 103 and the label control unit 102 determine the values of the parameters in the case where the error is small and the range for determining a positive label is large.

The processing in the model generation device 101 will be described with reference to an example in which the observation information is time points.

When the observation information is time points, the label control unit 102 specifies a time point similar to the time point of positive data in the temporal data sequence, and assigns a positive label to the data observed at the specified time point.

The label control unit 102 may assign a positive label to data related to observation information at a time point similar to a time point related to positive data and before a time point when the positive data occurs in a temporal data sequence. In this case, the label control unit 102 performs processing for propagating (assigning) a positive label to, among pieces of data observed before the occurrence time the positive data, data observed at a time point similar to the time point. For example, the processing is applicable when negative data changes to positive data over time.

The processing in the model generation device 101 will be described with reference to an example in which the observation information is an illumination angle.

Even when the observation information is an illumination angle, the similar processing to that in the case where the observation information is a time point runs. The illumination angle is, for example, a value from 0 degrees to 360 degrees. In this case, “a” (“a” is a real number) degrees and “a+360×N (where N is an integer)” degrees represent the same angle. Thus, angles such as illumination angles are parameters that take cyclical values. When a defect (for example, a scratch, defect, or crack) is detected under light irradiation at a certain illumination angle to a product, a positive label is assigned to data representing the product. In this case, a label control unit 102 assigns a positive label to data in a range having an angle difference with respect to an illumination angle where a defect has been detected. For example, the range may include two ranges of a range of 0 to 10 degrees, and a range of 350 to 360 degrees. In this case, the label control unit 102 assigns (propagates) a positive label to data when the angular difference between the positive data and the illumination angle is equal to or more than 350 degrees and data when the angular difference between the positive data and the illumination angle is equal to or less than 10 degrees.

The method of assigning a positive label by the label control unit 102 is not limited to the above-described example.

The data sequence may include unlabeled data. The processing of the model generation device 101 when the data sequence includes unlabeled data will be described.

The observation information is assumed to numerical data for convenience of explanation. It is assumed that as the numerical data represented by the observation information increases with respect to the data included in the data sequence, the label for the data changes from a negative label to a positive label. It is assumed that, even when the numerical data represented by the observation information is further increased with respect to the data included in the data sequence, the label for the data does not change from a positive label to a negative label. In this case, the label control unit 102 assigns a positive label to an unlabeled data when observation information related to the unlabeled data is included in a range for determining a positive label. The label control unit 102 assigns a negative label to the unlabeled data when observation information related to the unlabeled data is out of a range for determining a positive label.

Referring to an example in which the model generation unit 103 generates a model related to a positive label and a negative label, the processing in the model generation device 101 has been described. However, the model generated by the model generation unit 103 does not necessarily have to be a two-class discriminator, but may be a multiclass discriminator of three or more classes or a regression model. The model is not limited to the example described above.

Next, the advantageous effect of the model generation device according to the first example embodiment of the present invention will be described.

The model generation device 101 according to the first example embodiment can achieve reduction of risk for an observation target. The reason for this is that a model generated by the model generation device 101 for the observation target has a high discrimination performance, and it results in reducing the risk of making an incorrect determination about the observation target such as the observation target. The following shows the reason for this in detail.

When scale of a target event occurring in an observation target is small or when it is difficult to determine whether a target event is occurring, incorrect determination on whether the target event is occurring may happen. When a model for determining whether the target event is occurring in the observation target is generated by a machine learning technique, the model is generated based on data including incorrect data of determination. Therefore, it is likely that the generated model has a low discrimination performance.

The inventors of the present application have found the regularity that when an observation target has been observed in a series of observation environments, in the observation environments similar to each other, it is likely that the same event is occurring in the observation target. Therefore, the inventors of the present application have found a regularity that the data observed in the observation environments is likely to be assigned with labels indicating that the event is occurring. The model generation device 101 performs the processing described above with reference to FIG. 2 based on the regularity. As a result, the model generation device 101 assigns similar labels to pieces of data observed in similar observation environments to each other. Therefore, even if a label includes an incorrect label, the model generation device 101 can update the incorrect label based on the observation information. Therefore, the model generation device 101 can generate a model having high discrimination performance. In other words, the model generation device 101 reduces a risk of making incorrect determination with respect to the observation target such as the observation target.

### Second Example Embodiment

Next, a second example embodiment of the present invention will be described.

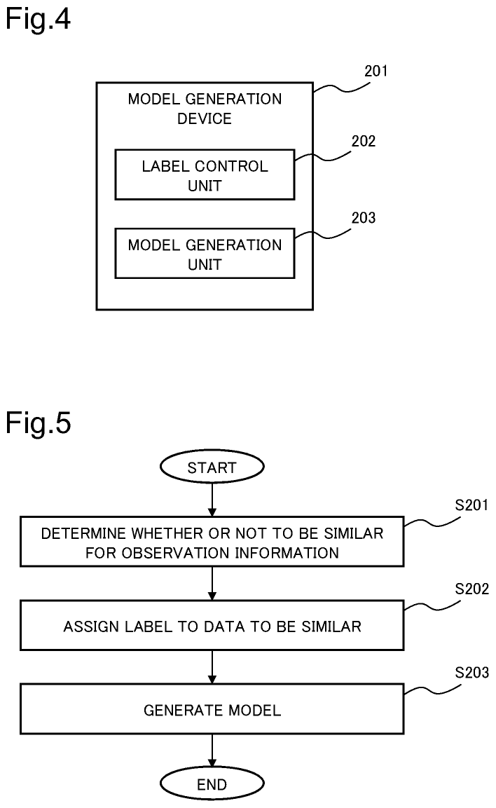

Referring to FIG. 4, a configuration of a model generation device 201 according to a second example embodiment of the present invention will be described in detail. FIG. 4 is a block diagram showing a configuration of the model generation device 201 according to the second example embodiment of the present invention.

The model generation device 201 according to the second example embodiment includes a label control unit 202 and a model generation unit 203.

The model generation device 201 inputs a data sequence including a plurality of pieces of data, observation information, and a label related to the data.

Observation information is data acquired when the observation target is observed in a certain observation environment (situation) and the observation information represents the environment (situation) in which the data is observed. The label indicates whether the target event is occurring for the observation target when the observation target is observed in the certain observation environment (or possibility of occurrence of the target event).

For convenience of explanation, it is assumed that the data sequence includes first data and second data. It is assumed that the observation information includes observation information related to the first data and observation information related to the second data. It is assumed that a label is assigned to the second data.

Next, referring to FIG. 5, the processing in the model generation device 201 according to the second example embodiment of the present invention will be described in detail. FIG. 5 is a flowchart showing a flow of processing in the model generation device 201 according to the second example embodiment.

The label control unit 202 determines whether a label related to first data is similar to a label related to second data based on a degree of similarity between observation information representing an observed state of the first data and observation information representing an observed state of the second data (step S201). The label control unit 202 calculates, for example, the degree of similarity between the two pieces of observation information, and determines whether the degree of similarity satisfies a determination condition for determining whether it is similar. Alternatively, for example, when pieces of data are arranged in the order based on the observation information in the data sequence, the label control unit 202 determines whether the first data is arranged within a predetermined range (that is, a range for determining to be similar) from the second data in the data sequence to determine whether the label of the first data is similar to the label of the second data. When the observation information is numerical data, the label control unit 202 calculates the distance between the two pieces of numerical data, and determines whether the label of the first data is similar to the label of the second data based on the calculated distance. The processing for determining whether to be similar labels is not limited to the above-described example.

When determining that the observation information related to the first data is similar to the observation information related to the second data, the label control unit 202 assigns a label of the second data as a label of the first data (step S202).

Next, the model generation unit 203 reads the data information and the label information, and generates a model representing relevance (relationship) between the read data information and the read label information (step S203). The data information represents data including the first data and the second data. The label information includes a label of the first data and a label of the second data.

The label control unit 202 can be achieved by a function similar to that of the label control unit 102 shown in FIG. 1. The model generation unit 203 can be achieved by a function similar to that of the model generation unit 103 shown in FIG. 1. Therefore, the model generation device 201 can be achieved by a function similar to that of the model generation device 101 shown in FIG. 1.

Next, the advantageous effect of the model generation device 201 according to the second example embodiment of the present invention will be described.

The model generation device 201 according to the second example embodiment can achieve reduction of a risk of an observation target. The reason for this is that a model generated by the model generation device 201 for the observation target has high discrimination performance, and that results in reduction of the risk of making an incorrect determination about the observation target such as the observation target. The reason for this will be described in detail.

When scale of a target event occurring in an observation target is small or when it is difficult to determine whether the target event is occurring, incorrect determination on whether the target event is occurring may happen. When a model for determining whether the target event is occurring in the observation target is generated by a machine learning technique, the model is generated based on the data including incorrect data in the determination. Therefore, it is likely that the generated model has a low discrimination performance.

The inventors of the present application have found a regularity that when an observation target has been observed in a series of observation environments, in the observation environments similar to each other, it is likely that the same event is occurring in the observation target. Therefore, the inventors of the present application have found a regularity that the data observed in the observation environments is likely to be assigned with labels indicating that the event is occurring. The model generation device 201 performs the processing described above with reference to FIG. 2 based on the regularity. As a result, the model generation device 201 assigns similar labels to pieces of data observed in observation environments that are similar to each other. Therefore, even if a label includes an incorrect label, the model generation device 201 can update the incorrect label based on the observation information. Therefore, the model generation device 201 can generate a model having high discrimination performance. In other words, the model generation device 201 reduces the risk of making incorrect determination with respect to the observation target such as the observation target.

(Hardware Configuration Example)

A configuration example of hardware resources that achieve a model generation device according to each example embodiment of the present invention using a computer processing device (information processing device, computer) will be described. However, the model generation device may be achieved using physically or functionally at least two calculation processing devices. Further, the model generation device may be achieved as a dedicated device.

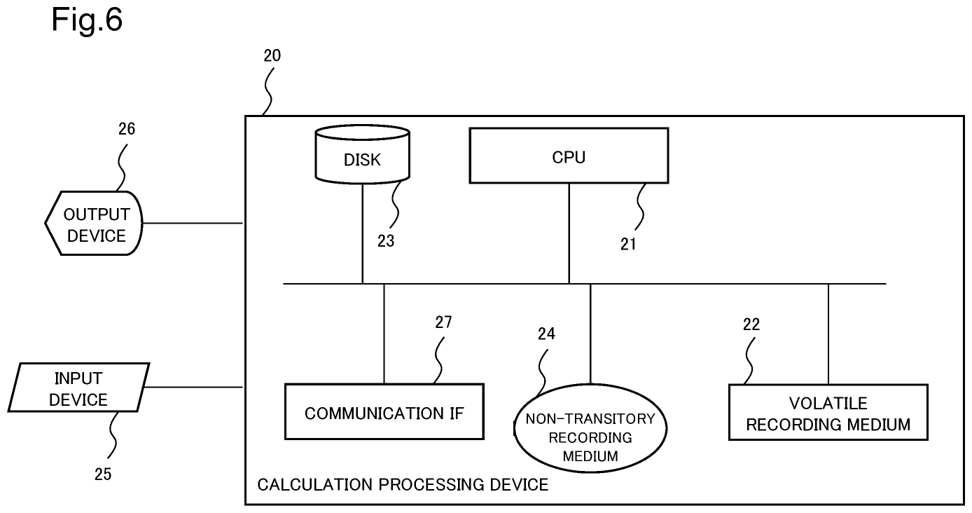

FIG. 6 is a block diagram schematically illustrating a hardware configuration of a calculation processing device capable of achieving a model generation device according to each of the example embodiments of the present invention. A calculation processing device 20 includes a central processing unit (CPU) 21, a volatile recording medium 22, a disk (disc) 23, a non-transitory recording medium 24, and a communication interface (hereinafter, expressed as. “communication I/F”) 27. The calculation processing device 20 may connect an input device 25 and an output device 26. The calculation processing device 20 can execute transmission/reception of information to/from another calculation processing device and a communication device via the communication I/F 27.

The non-transitory recording medium 24 is, for example, a computer-readable Compact Disc, Digital Versatile Disc. The non-transitory recording medium 24 may be Universal Serial Bus (USB) memory, Solid State Drive or the like. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory recording medium 24.

The volatile recording medium 22 is computer-readable and can store data temporally. The volatile recording medium 22 is a memory or the like such as DRAM (dynamic random access memory), SRAM (static random access memory), and the like.

In other words, the CPU 21 copies, on the memory 22, a software program (a computer program: hereinafter, referred to simply as a “program”) stored in the disk 23 when executing the program and executes arithmetic processing. The CPU 21 reads data necessary for program execution from the memory 22. When display is needed, the CPU 21 displays an output result on the output device 26. When a program is input from the outside, the CPU 21 reads the program from the input device 25. The CPU 21 interprets and executes a model generation program (FIG. 2 or FIG. 5) present on the memory 22 corresponding to a function (processing) indicated by each unit illustrated in FIG. 1 or FIG. 4 described above. The CPU 21 sequentially executes the processing described in each example embodiment of the present invention.

In other words, in such a case, it is conceivable that the present invention can also be made using the model generation program. Further, it is conceivable that the present invention can also be made using a computer-readable, non-transitory recording medium storing the model generation program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

### REFERENCE SIGNS LIST

101 model generation device
102 label control unit
103 model generation unit
151 data sequence storage unit
152 label information storage unit
153 observation information storage unit
154 model information storage unit
155 parameter information storage unit
301 data
302 data
303 data
304 data
305 event
306 event
307 event
308 negative label
309 negative label
310 positive label
311 positive label
312 data sequence
313 label information
201 model generation device
202 label control unit
203 model generation unit
20 calculation processing device
21 CPU
22 volatile recording medium
23 disk
24 non-transitory recording medium
25 input device
26 output device
27 communication IF

What is claimed is:

1. A model generation device comprising:
a memory for storing instructions; and
a processor connected to the memory and configured to execute the instructions to:
determine whether or not a label of a first data is similar to a label of a second data and assign the label of the second data to the first data when determining that the label of the first data is similar to the label of the second data based on a degree of similarity between observation information representing a state where the first data is observed and observation information representing a state where the second data is observed; and
calculate model representing a relevance between data information containing the first data and the second data and label information containing the assigned label and the label of the second data.

2. The model generation device according to claim 1, wherein
the processor is configured to execute the instructions to
calculate the degree of similarity to the observation information of the second data for data in a data sequence containing the first data and the second data, determines whether or not the data is similar to the second data based on the calculated degree, and assigns the label of the second label to data determined to be similar.

3. The model generation device according to claim 1, wherein
the processor is configured to execute the instructions to
calculate discrimination performance of the calculated model and
determine whether or not to assign the label of the second data to the first data based on the calculated discrimination performance.

4. The model generation device according to claim 3, wherein
the processor is configured to execute the instructions to
assign a value depending on the calculated degree to the first data as a soft label, calculate a range of the observation information for determining the soft label based on the calculated discrimination performance, and determine the soft label assigned to the first label based on the calculated range.

5. The model generation device according to claim 1, wherein
the processor is configured to execute the instructions to, when the data sequence containing the first data and the second data includes an unlabeled data having no label, assign a label of the unlabeled data in accordance with the calculated degree.

6. The model generation device according to claim 4, wherein
the processor is configured to execute the instructions to
calculate model in case that an objective function including discrimination performance of the model and the range is decreased when calculating the model,
the smaller a value of the objective function is, the higher the discrimination performance is higher, and
the smaller a value of the objective function is, the wider the range for assigning the label of the second data is.

7. The model generation device according to claim 1, wherein
data observed for an observation target is ordered in chronological order in the data sequence containing the first data and the second data and
the processor is configured to execute the instructions to
determine whether or not to assign the label of the second data in descending order of similarity to the second data in the data sequence

8. The model generation device according to claim 1, wherein
the observation information is numerical data,
data observed for an observation target is ordered in order of the numerical data being the observation information in the data sequence containing the first data and the second data, and
the processor is configured to execute the instructions to
determine whether or not to assign the label of the second data in descending order of similarity to the second data in the data sequence.

9. A model generation method by an information processing device comprising:
determining whether or not a label of a first data is similar to a label of a second data and assigning the label of the second data to the first data when determining that the label of the first data is similar to the label of the second data based on a degree of similarity between observation information representing a state where the first data is observed and observation information representing a state where the second data is observed; and
calculating model representing a relevance between data information containing the first data and the second data and label information containing the assigned label and the label of the second data.

10. A non-transitory recoding medium for storing a model generation program causing a computer to achieve:
a label control function configured to determine whether or not a label of a first data is similar to a label of a second data and assign the label of the second data to the first data when determining that the label of the first data is similar to the label of the second data based on a degree of similarity between observation information representing a state where the first data is observed and observation information representing a state where the second data is observed; and
a model generation function configured to calculate model representing a relevance between data information containing the first data and the second data and label information containing the assigned label and the label of the second data.
